(19) United States
(12) Patent Application Publication
(10) Pub. No.: US 2010/0288989 A1
(43) Pub. Date: Nov. 18, 2010

(54) Fence System

(75) Inventors: Ryan Williams, Orange, TX (US); Richard Hinds, Orange, TX (US); Doyle Hinds, Orange, TX (US)

Correspondence Address: ARNOLD & KNOBLOCH, L.L.P., 4900 Woodway Dr., Suite 900, HOUSTON, TX, 77056, US

(73) Assignee: A-1 American Fence, Inc., Orange, TX (US)

(21) Appl. No.: 12/781,913

(22) Filed: May 18, 2010

Related U.S. Application Data
(60) Provisional application No. 61/179,360, filed on May 18, 2009.

(51) Int. Cl. E04H 17/14; B23P 17/04

(52) U.S. Cl. 256/59; 29/428

(57) ABSTRACT

A fence system including a T-shaped pole member having a receiving surface and a leg, an L-shaped rail member, and a facing member. The leg of the pole member has a plurality of spaced apart hole members capable of receiving a bendable raceway. The receiving surface of the pole member has a hole capable of providing means for pivoting and affixing the pole member to the rail or to the facing member. The rail member has an elliptical hole capable of providing means for pivoting and affixing the rail member to the receiving surface of the pole member. The combination of the pivotally affixed pole member and the rail member is positioned and arranged to be capable of adjusting the fence system to non-level terrains. The combination of the pole member and the rail member is positioned and arranged to be capable of receiving the raceway between adjacent holes, independent of the terrain and independent of the positioning of a plurality of the poles.

### STATEMENT OF RELATED CASES

This application claims the benefit of U.S. Provisional Application No. 61/179,360 of filing date May 18, 2009.

### FIELD OF THE INVENTION

This invention relates to fences and in particular a fence system and method that provides an alternate to placement of underground utilities.

### BACKGROUND

For perimeter security fencing, there is a need for avoidance of existing underground utilities and other existing underground objects. Typically, retrofits to existing facilities have a significantly higher cost than that of new construction because of the cost of additional care required to avoid and not damage existing utilities or structures. Further, there are additional costs to replace or repair existing objects, structures, or utilities that cannot be worked-around. Further, existing underground utilities cannot always be located. Damage to these unforeseen obstructions can cause outages and personal injuries. Additionally, many security systems are currently run underground, further congesting the underground, below-grade real estate. The applicant has realized that there is a need to reduce the below-grade footprint, to reduce post spacing, and/or to reduce trenching or boring.

Applicant has discovered a need for a fence system that cost-effectively allows for utilities to be run such that costly underground emplacement is avoided. Applicant also realizes a need for an ability to cost effectively retrofit security utilities during upgrade of a facility. Various utilities include, for example, high and low voltage electrical, water lines, gas lines, communication, fiber, and security systems. To further avoid high excavation costs and address general environmental issues, there is a need for an ability to remove or relocate security utilities and fence systems as the fence system or utilities are no longer needed. Abandonment is currently a typical method, since excavation costs are high.

U.S. Patent Application Publication US2009/0321701 to Payne discloses a fence horizontal rail that can be used as a conduit for communicating video, data tamper detection signals, electrical power, and water. The inherit flaw with this approach of running these items through their rails is that their system attaches the rails by driving screws, bolts, or some sort of fasteners through the rail which will impede the passage of the cable through the rail. The penetrations also do not allow for a weather tight seal. The fasteners attaching the rail will also significantly increase the difficulty of installing the wire as well as having the potential to damage the wire while being installed causing it to short out or cause other damage. In reference to using the rail as a conduit for water, the rail is not water tight.

Applicant realizes that there remains a need for a fence system that allows industry-approved devices to be run in a manner allowing for those devices to be easily emplaced while maintaining their integrity and seals. There also is a need for a system that allows for future installation and removal of utilities and devices. Many of these devices and utilities are conveyed in a conduit or other similar piping type of structure. There is a need for such devices to be run in a manner allowing for them to maintain their full integrity and remain weather resistant and/or water tight. Further, there is a need for the conveyancing structure of the devices or utilities to be capable of travelling independently of any non-level terrain, or, at least to be run without having to make unnecessary bends. In general, many devices have limitations on radius of curvature and/or limits on the total of the bend angles over a particular span.

There is also a need for utilities to terminate, change direction, or many any of various required transitions. For example, when a new light needs to be run in a parking lot, typically construction practice dictates that trenching and/or boring back to the power source is required. There is a need for reducing the length of the trenching or boring, especially in the presence of existing pavement, in order to provide a faster and more cost effective method of providing power and communications to the light.

Applicant has discovered as a result of the development of the present invention that there is also a need for reducing the shipping costs of security fencing. Fencing is generally light, but large in size. A freight truck is typically filled in volume at well below its maximum hauling weight. There is a need for tighter packaging, without sacrificing installation time and costs, so as to provide more fencing product per truck load.

All of these needs must also be met with a fence system whose structure features remain capable of supporting facing members, such as pickets and/or wire mesh. The system must also provide at the same time a level of tamper resistance and protection to the utility and device conduits. As seen from the art of record, how to meet this combination of needs is not readily apparent.

In further comment of U.S. Patent Application Publication US2009/0321701 to Payne, Payne fails to disclose use of a T-shaped pole member and does not disclose use of pole members as raceways. Payne discloses a rail used as a conduit for electrical and water. As such, the rail will not function as a bendable raceway as the rail is a structural member of the fence and bending it would affect the integrity of the fence. Further, the mounting brackets that attach the rail to the pole have multiple fasteners that penetrate the rail. These fasteners can potentially damage wires or hoses. The fasteners further provide installation difficulty for running any hoses or conduits. The pole member also does not have a hole for the rail as it relies on a bracket for attachment and therefore does not have a means for the rail to pivot. This is also seen in that the rail member has a swedged end where the rails slide together. The rail is not capable of pivoting and prevents racking capability of the fence. Therefore, the combination of pole and rail is not capable of adjusting the fence system to non-level terrain. Even though the rail is disclosed to be used as a conduit, the rail-conduit is not capable of travelling independently of the terrain.

U.S. Pat. No. 7,134,646 to Brooks et al. discloses a completely roll formed privacy fencing system. Brooks fails to disclose use of a T-shaped pole member and does not disclose use of spaced-apart holes capable of forming a raceway or holding a bendable raceway. Further, the rail member uses a self tapping screw to attach to the pole member. The rail can be set non perpendicular to the pole member but the rail cannot pivot, prevents racking capability of the fence. The system can follow non-level terrains but the system references adjusting the individual pickets for non-level terrain, not adjusting the pole and rail member. To follow non-level terrains, the fence must be assembled on location.

U.S. Pat. No. 5,772,186 to Parker discloses a fence using L-Shaped flat sided posts and rails. Parker fails to disclose use of a post leg member providing use of spaced-apart holes capable of forming a raceway or holding a bendable raceway. Parker discloses multiple holes in the post for receiving rails, but does not disclose a means for the rail to pivot when attached. The fence cannot follow non-level terrains, given the means for attaching the rails to the poles. Brooks does not disclose a capability for receiving raceway independent of the terrain using adjacent holes in the post, those holes capable of forming a raceway or holding a bendable raceway.

U.S. Pat. No. 5,860,636 to Duncan discloses a sheet metal rolled fence post. Duncan fails to disclose use of pole members with spaced-apart holes capable of forming a raceway or holding a bendable raceway. Duncan does not disclose a post configured for holes capable of receiving restraining cables. Duncan does not disclose use of pivoting rail members in combination with pole members. The use of fold back edges for the structural configuration of the post member is not disclosed.

U.S. Patent Application Publication US2005/0189532 A1 to Gasaway et al. discloses a fence brace assembly. Gasaway fails to disclose a T-shaped pole structure. Gasaway fails to disclose a hole for receiving bendable raceway, and does not disclose a brace member having a hole and being capable of pivoting. Gasaway fails to disclose a rail having a mitered edge proximate to a rail hole. Gasaway fails to disclose a pole member and rail member combination capable of adjusting to non-level terrains. Gasaway fails to disclose a pole member and rail member combination capable of receiving a raceway between adjacent holes, independent of terrain.

### SUMMARY

In a first set of examples, a fence system is disclosed, the fence system including a T-shaped pole member having a receiving surface and a leg, a rail member, and a facing member. The leg of the pole member has a plurality of spaced apart hole members capable of receiving a bendable raceway. The receiving surface of the pole member has a hole capable of providing means for pivoting and affixing the pole member to the rail or to the facing member. The rail member has an elliptical hole positioned and arranged so as to be capable of providing means for pivoting and affixing the rail member to the receiving surface of the pole member. The rail member has a tapered or mitered edge proximate to the rail hole, the rail member capable of pivoting with respect to the pole member about the axis of the hole of the pole member. The combination of the pivotally affixed pole member and the rail member is positioned and arranged so as to be capable of adjusting the fence system to non-level terrains. The combination of the pole member and the rail member is positioned and arranged so as to be capable of receiving the raceway between adjacent holes independent of the terrain and independent of the positioning of a plurality of the poles.

In another example, the T-shaped pole member has fold-back edges.

In another example, the rail member is L-shaped. In a further example, the L-shaped rail member has fold-back edges. In a further example, one pole member or one rail member has fold-back edges.

In another example, the spaced apart hole members of the leg of the pole member are elongated along the longitudinal direction of the leg.

In another example, the leg of the pole member further comprises a second set of holes, the second set of holes capable of receiving a set of restraining cables at a predefined spacing. In a further example, the fence system further includes a set of restraining cables disposed through the second set of holes, the second set of holes positioned and arranged to comply with a crash resistant fencing standard.

In another example, the fence system is positioned and arranged so as to be capable of racking.

In another example, the facing member includes a plurality of pickets, forming a combination of pole members, rail members, and pickets. In another example, the pickets are pivotally affixed to the rail members. In another example, the facing member includes a chain link web. In another example, the facing member comprises a wire mesh.

In another example, the pole member and the rail member are positioned and arranged so as to be capable of adjusting the fence to non level terrains.

In another example, the T-shaped pole member is a rolled form construction. In another example, the rail member is a rolled form construction. In another example, one pole member or one rail member is a rolled form construction.

In a second set of examples, a fence system is disclosed, the fence system including a T-shaped pole member having a receiving surface and a leg. The T-shaped pole member has fold-back edges, the T-shaped pole member is a rolled form construction, the leg of the pole member has a plurality of spaced apart hole members capable of receiving a bendable raceway, the spaced apart hole members of the leg of the pole member are elongated along the longitudinal direction of the leg, and the leg of the pole member further comprises a second set of holes, the second set of holes capable of receiving a set of restraining cables at a predefined spacing. The fence system further includes an L-shaped rail member. The L-shaped rail member has fold-back edges, and the L-shaped rail member is a rolled form construction. The fence system further includes a facing member. The receiving surface of the pole member has a hole capable of providing means for pivoting and affixing the pole member to the rail or to the facing member. The rail member has an elliptical hole positioned and arranged so as to be capable of providing means for pivoting and affixing the rail member to the receiving surface of the pole member.

The rail member has a tapered or mitered edge proximate to the rail hole, the rail member capable of pivoting with respect to the pole member about the axis of the hole of the pole member. The combination of the pivotally affixed pole member and the rail member is positioned and arranged so as to be capable of adjusting the fence system to non-level terrains. The combination of the pole member and the rail member is positioned and arranged so as to be capable of receiving the raceway between adjacent holes independent of the terrain and independent of the positioning of a plurality of the poles.

In one example, the fence system further includes a set of restraining cables disposed through the second set of holes, the second set of holes positioned and arranged to comply with a crash resistant fencing standard.

In another example, the fence system is positioned and arranged so as to be capable of racking.

In another example, the facing member includes a plurality of pickets, forming a combination of pole members, rail members, and pickets. In another example, the facing member includes a chain link web. In another example, the facing member comprises a wire mesh.

In a third set of examples, a method for constructing a fence system is disclosed, the method including: disposing a plurality of T-shaped pole members having a receiving surface and a leg, the leg of the pole member having a plurality of spaced apart hole members capable of receiving a bendable raceway, the receiving surface of the pole member having a hole capable of providing means for pivoting and affixing the pole member to a rail or to a facing member; disposing a plurality of rail members on the T-shaped pole members, the rail members having an elliptical hole positioned and arranged so as to be capable of providing means for pivoting and affixing the rail member to the receiving surface of the pole member, the rail members having a tapered or mitered edge proximate to the rail hole, the rail member capable of pivoting with respect to the pole member about the axis of the hole of the pole member; positioning and arranging the combination of the pivotally affixed pole members and the rail members so as to be capable of adjusting the fence system to non-level terrains; positioning and arranging the combination of the pole member and the rail member so as to be capable of receiving a raceway between adjacent pole member holes independent of the terrain and independent of the positioning of a plurality of the poles; and diposing a facing member on the rail members.

In another example, the method further includes inserting a conduit through a hole of the pole members.

In another example, the method further includes fixing the pivot relationship between the pole member and the rail member.

In another example, the facing member includes pickets. In a further example, the pickets are pivotally affixed to the rail members.

In another example, the method further includes fixing the pivot relationship between the fencing member and the rail member.

### BRIEF DESCRIPTION OF THE DRAWINGS

The present invention is best understood with reference to the attached drawings in which like numerals refer to like elements, and in which:

FIG. 1 illustrates a front facing view of an example of the fence system installed on an uneven terrain;

FIG. 2 illustrates a front facing view of an example of the fence system installed on an uneven terrain with a facing member installed;

FIG. 3 illustrates a frontal facing perspective view of an example of the fence system in partial cut-away to show examples of facing members and options for running raceways;

FIG. 4 illustrates a frontal perspective view of an example of pole member 10 and rail member 20 attached by a fastener, such as a nut and bolt;

FIG. 5 illustrates a side end view of rail member 20;

FIG. 6 illustrates a top view of rail member 20;

FIG. 7 illustrates a front view of rail member 20;

FIG. 8 illustrates a top view of pole member 10;

FIG. 9 illustrates a side view of pole member 10;

FIG. 10 illustrates a front view of pole member 10;

FIG. 11 illustrates a behind facing perspective view of an example of the fence system showing “racking” on a sloped terrain;

FIG. 12 illustrates a behind view of pole member 10 and pivotally attached rail member 20 in perpendicular attachment;

FIG. 13 illustrates a behind view of pole member 10 and pivotally attached rail member 20 in angled attachment;

FIG. 14 illustrates a top view of rail member 20 with an example of attachment of picket 30;

FIG. 15 illustrates a top view of an example of holding plate 41 and bolt 42 for picket attachment;

FIG. 16 illustrates a front view of an example of holding plate 41 and bolt 42 for picket attachment;

FIG. 17 illustrates a side view of an example of holding plate 41 and bolt 42 for picket attachment;

FIG. 18 illustrates a top view of an example of an integrated bolt 45 for picket attachment; and

FIG. 19 illustrates a perspective view of an example of an integrated bolt 45 for picket attachment.

### DETAILED DESCRIPTION

The present fence system arose out of necessity. There currently are fences that hold crash rated cables and intrusion detections systems but other items still need to be run to their locations, which normally consist of slow and more expensive means of construction.

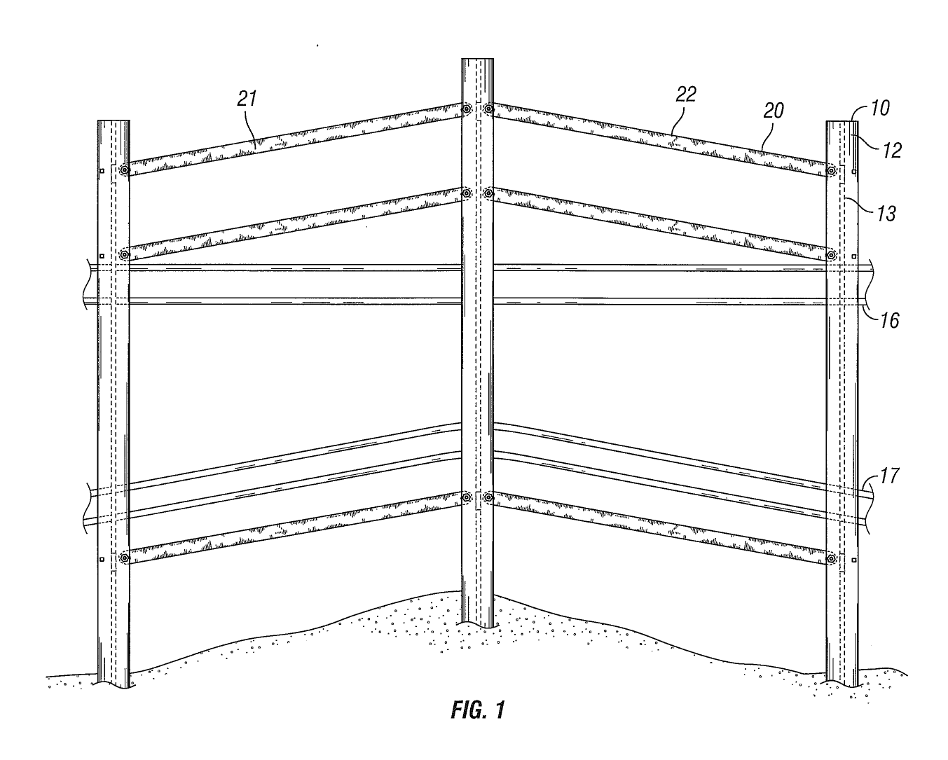

FIG. 1 illustrates the fence system installed on an uneven terrain. A plurality of pole members 10 are emplaced in a vertical direction relative to the surface of the ground. A plurality of rail members 20 are pivotally attached to adjacent pole members 10, one end of each rail member 20 is attached to one pole member 10 and the other end of rail member 20 is attached to an adjacent pole member 10.

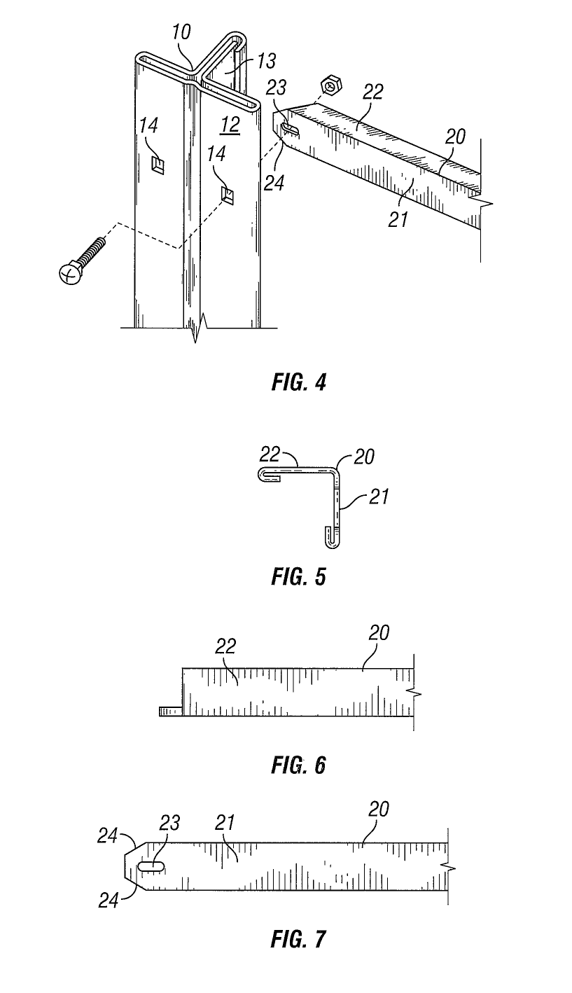

Pole member 10 is constructed such that it has a receiving surface 12 for receiving rail members 20 and facing surfaces. Receiving surface 12 is generally oriented to be parallel to the plane of the desired barrier. Generally perpendicular to receiving surface 12, pole member 10 is constructed to have a surface or leg 13 extending from the plane of the desired barrier. In one example, this results in pole member 10 having a T-shape construction, which will be detailed in FIGS. 4 and 8-10. Receiving surface 12 forms the cap or arm of the “T” while leg 13 forms the vertical stroke or stem of the “T”. Leg 13 provides additional structural strength and integrity to pole member 10.

In one example pole member 10 includes a base plate welded on near one end to facilitate anchoring the pole member into concrete or wood.

In one example, pole member 10 is constructed to have spaced apart elongated holes (illustrated in FIG. 9) in leg 13. Leg 13 therefore provides a bracket or means for receiving conduits or raceways, or otherwise acts as a raceway receptacle. Raceways 16 traverse along the fence, supported by holes in leg 13 of pole member 10. In one example, raceways 16 are maintained relatively horizontal, independent of the variations in the level of the terrain. In another example, bendable raceway 17 traverse along the fence, supported by holes in leg 13 of pole member 10. In one example, raceways 17 are not necessarily maintained relatively horizontal. In one example, raceways 17 traverse along the fence at a level that varies approximately with the variations in the level of the terrain. Raceways 16 and raceways 17 are disposed on the fence independent of rail members 20. As shown in FIG. 1, bendable raceways 17 are shown having a gentle bend or large radius of curvature, without abrupt kinks or sharp bends.

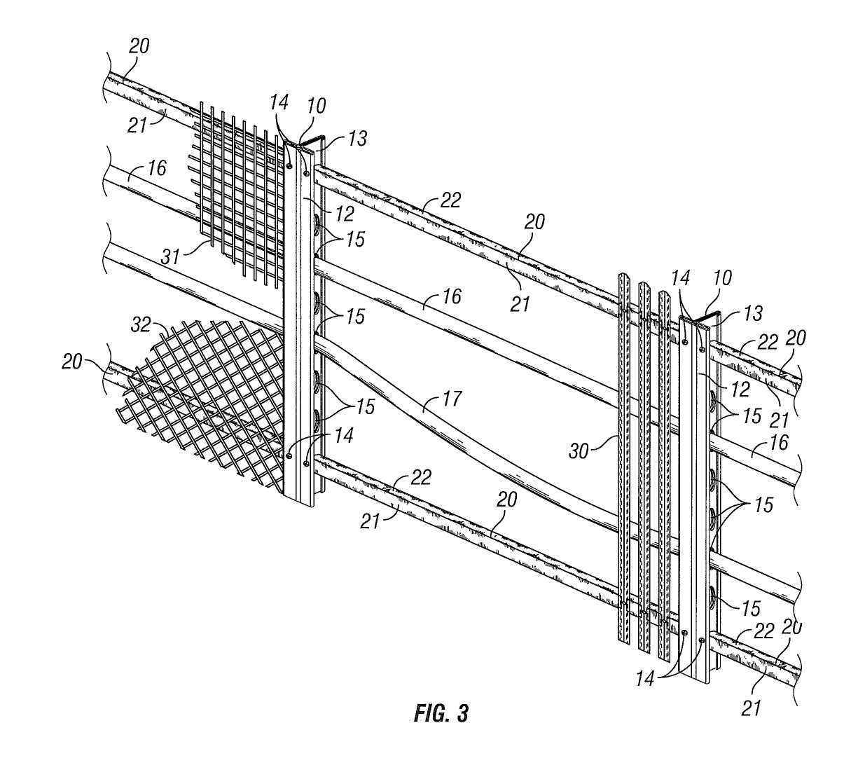

One important aspect of certain utility runs is that the total angle of bend is kept to a minimum. Certain specifications require that the total angle of bend in a run is kept below a certain number of degrees for a given length of run. As the total of the angles of bend increase, the ability to snake a conduit or raceway decreases. Therefore, it is important to provide a type of structural support to the raceway that enables running the raceway or conduit in such a way as to minimize the total angle of bend. This solves a long standing problem in being able to run conduit or pipe so as to meet requirements or local codes, especially with regard to maximum allowable bend. In one example, rail member 20 is constructed such that it has a rail receiving surface 21 and a rail leg 22 (as illustrated in FIGS. 3-6 and 8). Rail receiving surface 21 is generally oriented to be parallel to the plane of the desired barrier. Generally perpendicular to rail receiving surface 21, rail member 20 is constructed to have a surface or rail leg 22 extending from the plane of the desired barrier. In one example, this results in rail member 20 having an L-shape construction, which will be detailed in FIGS. 3-6 and 8. Rail receiving surface 21 forms one arm of the “L” while rail leg 22 forms the other arm of the “L”. In one example, rail leg 22 provides additional structural strength and integrity to rail member 20.

The combination of T-shape for the pole member and L-shape for the rail member caused a surprising result. The shape of the post came about as a way to support both the conduit and to be able to support a facing member as well. Using L-shaped horizontal rails allowed the conduit to pass through without any impediments. The L-shaped rail also provides for tamper resistance to those conduits that need to be more protected. As a result, the pole members have an increased surface area that provides the pole member greater strength when driven in the ground in comparison to round or square posts driven in the ground. Another surprising result is that the shape of the fence stacks in smaller spaces which helps in reducing shipping costs.

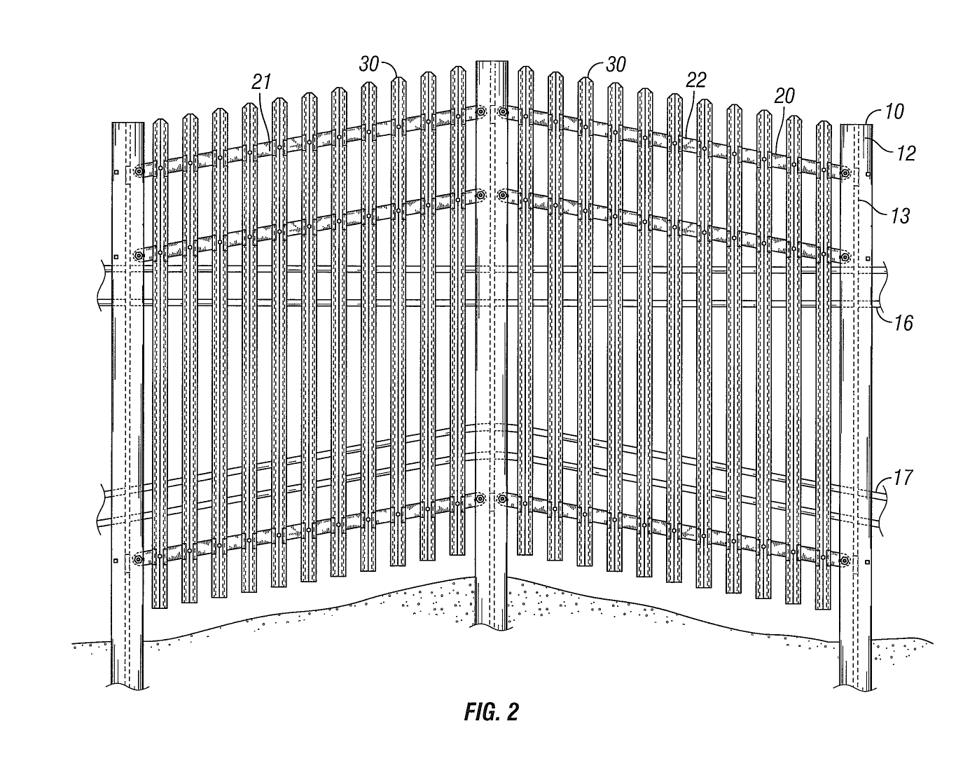

FIG. 2 illustrates the fence system installed on an uneven terrain with a facing member installed. In one example, the facing member includes pickets 30. Pickets 30 are pivotally affixed to rail members 20. By pivotally affixing pickets 30 to rail member 20, the fence becomes “rackable”. This means that the fence does not have to be installed perfectly horizontal to level. The fence is capable of following uneven elevation of terrain by simply allowing the rail members to glide up or down depending on the elevation of the pole members 10. In this example, the facing member does not have to be completely installed in the field, which is a very labor intensive and costly process. Instead, the rail member-picket assembly can be brought to the field pre-assembled and skewed into the desired orientation between two adjacent pole members 10. As will be detailed further in FIGS. 4 and 7, rail member 20 is designed to optimize attachment of the rail member-picket assembly to pole member 10 under these conditions.

One surprising result is the unexpected advantage in shipping the fence materials to the installation site. The shape of the post members and the rail members allow them to be packaged more tightly which helps to reduce shipping costs. The pivoting of the rails and facing member combination also allow them to be shipped with a reduced volume requirement. Generally, fencing is lighter but larger in volume. Therefore, a freight truck is typically full in volume without reaching its maximum limit in hauling weight. With the tighter packaging from the reduced size of the post and rail, the truck is be able to transport more material at maximum hauling weight. This allows more product to be shipped on the same truck, resulting in fewer truck loads to the installation or warehousing site. This has resulted in an unexpected advantage.

FIG. 3 illustrates the fence system in partial cut-away to show examples of facing members and options for running raceways. In one example, the facing member includes pickets 30, which are attached to rail receiving surface 21 of rail members 20. In another example, the facing member includes a chain link web 31, also attached to rail members 20. In another example, the facing member includes a wire mesh 32 attached to rail members 20. The different examples of facing members generally define the plane of the desired barrier. In other examples, facing members include, but are not limited to: woven fabric, welded fabric, wood, steel or aluminum pickets, or any other type of facing member.

Leg 13 provides a bracket or means for receiving conduits or raceways, or otherwise acts as a raceway receptacle by including holes 15 in leg 13. In one example, conduit or raceway 16 traverses along the fence structure in a manner that is parallel to the elevation of the fence. In one example, bendable conduit or raceway 17 traverses along the fence structure in a manner that is independent of the elevation of the fence. This is accomplished by selecting a particular hole 15 of a particular pole member 10 in which to run raceway 17.

In one example, the positioning and arrangement of leg 13 of pole member 10 and rail leg 22 of rail member 20 is illustrated in FIG. 3. Leg 13 of pole member 10 and rail leg 22 of rail member 20 are generally not parallel to the plane of the desired barrier, extending from the plane of the desired barrier and providing additional structural integrity.

In another example, a second set of holes is disposed on leg 13, these holes capable of receiving a set of restraining cables at a predefined spacing. These restraining cables have a specific vertical spacing relative to one another. In one example, these restraining cables are also kept at a predetermined height above the terrain. These restraining cables are calculated to provide an optimum barrier for particularly sized vehicles with an object of slowing or stopping such vehicles upon breeching the fence. In one example, the fence system further includes a set of restraining cables disposed through the second set of holes, the second set of holes positioned and arranged to comply with at least one crash resistant fencing standard or predefined spacing. FIG. 4 illustrates an example of pole member 10 and rail member 20 attached by a fastener, such as a nut and bolt. Receiving surface 12 of pole member 10 includes a square hole 14 configured to receive a bolt having a square locking shoulder. One end of rail member 20 will rotationally pivot about the axis of the hole 14 of the pole member 10. Rail receiving surface 21 is configured to dispose on the back side of receiving surface 12, the side also including leg 13 of pole member 10. Rail leg 22 of rail member 20 is configured to not interfere with leg 13 of pole member 10. A hole 23 in receiving surface 21 of rail 20 is configured to receive a bolt that is first is inserted in hole 14. In one example, hole 14 is square or otherwise shaped to securely receive the locking shoulder of the fastener. In one example, hole 23 is elliptical in configuration. The elliptical configuration enables adjustment of the position during final assembly in response to the amount of racking required of the fence. Receiving surface 21 of rail 20 includes a tapered or mitered edge 24 on the end of rail 20, near hole 23. Mitered edge 24 enables freedom of rotation of rail 20, configuring rail 20 to not interfere with leg 13 during assembly and under conditions of significant racking angle.

In one example, pole member 10 is shown as structurally constructed in a T-shaped configuration from a single piece of material. The leg and the receiving surface are formed by successive bends of the material such that receiving surface 12 and leg 13 are two layers of material. In a preferred example, pole member 10 is fabricated through the process of roll forming. Pre-galvanized coils of steel are split into their proper width and then placed onto a machine that cuts out holes and notches before submission to rolling guides. The guides form the steel to the correct shape and then cut the piece to length. Selecting various types and thickness of steel engenders the product with a particular strength and weight.

In one example, the longitudinal edges of the receiving surface 12 or leg 13 of pole member 10 are folded back. In one example, this obscures the sharp edges of the material used to construct pole member 10, increasing ease and safety in handling and during assembly of the fence.

FIG. 5 illustrates a side end view of rail member 20. In one example, receiving surface 21 and rail leg 22 of rail member 20 each form an arm of the L-shape. In one example, the longitudinal edges of the receiving surface 21 or rail leg 22 are folded back. In one example, this obscures the sharp edges of the material used to construct rail member 20, increasing ease and safety in handling and during assembly of the fence. Further, the rolled-back edges provide additional structural integrity and strength for a give type and thickness of material used for rail member 20.

In a preferred example, rail member 20 is fabricated through the process of roll forming. Pre-galvanized coils of steel are split into their proper width and then placed onto a machine that cuts out holes and notches before submission to rolling guides. The guides form the steel to the correct shape and then cut the piece to length. Selecting various types and thickness of steel engenders the product with a particular strength and weight.

FIG. 6 illustrates a top view of rail member 20. In one example, rail leg 22, one arm of the “L” shape, traverses longitudinally along the length of rail member 20. In one example, at least a portion of tapered edge 24 does not include a rail leg 22, increasing the freedom of movement and access to rail member 20 when attaching to pole member 10.

FIG. 7 illustrates a front view of rail member 20. In one example, receiving surface 21 traverses longitudinally along the length of rail member 20. Receiving surface 21 of rail 20 includes a tapered or mitered edge 24 on the end of rail 20, near hole 23. In one example, hole 23 is elliptical in configuration. The elliptical configuration enables adjustment of the arrangement and positioning of rail member 20 to pole member 10 during final assembly, which may be in response to the amount of racking required of the fence. Mitered edge 24 enables freedom of rotation of rail 20, configuring rail 20 to not interfere with leg 13 during assembly and under conditions of significant racking angle.

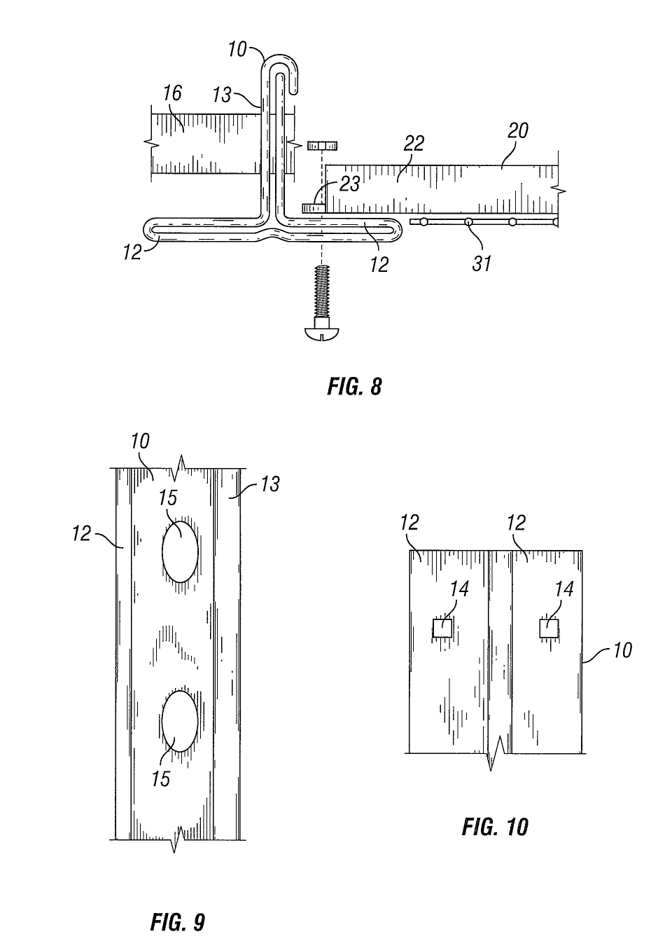

FIG. 8 illustrates a top view of pole member 10. In one example, conduit or raceway 16 is shown traversing through leg 13 of pole member 10, approximately parallel to the barrier plane formed by receiving surface 12 and the facing member, such as chain link web 31. Rail member 20 is pivotally affixed to pole member 10 by applying a fastener, such as a bolt and nut, through receiving surface 12 of pole member 10 and hole 23 of rail member 20. Rail 22 of rail member 20 forms a ledge which generally does not interfere with the traverse of raceway 16. In one example, the top view of pole member 10 exposes the rolled form construction of pole member 10, including a fold-back at the edge of leg 13 on one edge of the single piece construction to obscure the opposite edge of the single piece construction.

In one example, pole member 10 is constructed to have a dimple running longitudinally down the middle of the exterior surface of receiving surface 12, opposite the side having leg 13.

FIG. 9 illustrates a side view of pole member 10. In one example, leg 13 of pole member 10 is shown with elongated holes 15 disposed in leg 13, the elongation generally in the longitudinal direction of the pole member. In one example, the amount of elongation is in the ratio of 1 1/16 to 1. In one example, the amount elongated hole is 1.5 inches by 1.75 inches. The dimensions of the elongation, in one example, provide for the running of a one inch inside diameter conduit at up to a fifteen (15) degree angle without having to make any adjustments through the pole members. At greater than a fifteen (15) degree angle the conduit would have to make a bend to go through the pole members. Increasing the elongation from 1.75 inches to 2 inches allows for a twenty (20) degree angle. Increasing the elongation, however, increases the size of the hole and significantly weakens the pole members. From this side view, an edge view of receiving surface 12 is seen on one side of the face of leg 13. In one example, the fold-back of the single piece construction is seen on the other side of the face of leg 13.

FIG. 10 illustrates a front view of pole member 10. In one example, holes 14 are disposed on and through receiving surface 12 of pole member 10. In one example, holes 14 are shaped to securely receive a locking shoulder of a fastener. In one example, hole 14 is square to securely receive the locking shoulder of a bolt having a square locking shoulder. In one example, pole member 10 is constructed to have a dimple running longitudinally down the middle of the exterior surface of receiving surface 12, opposite the side having leg 13.

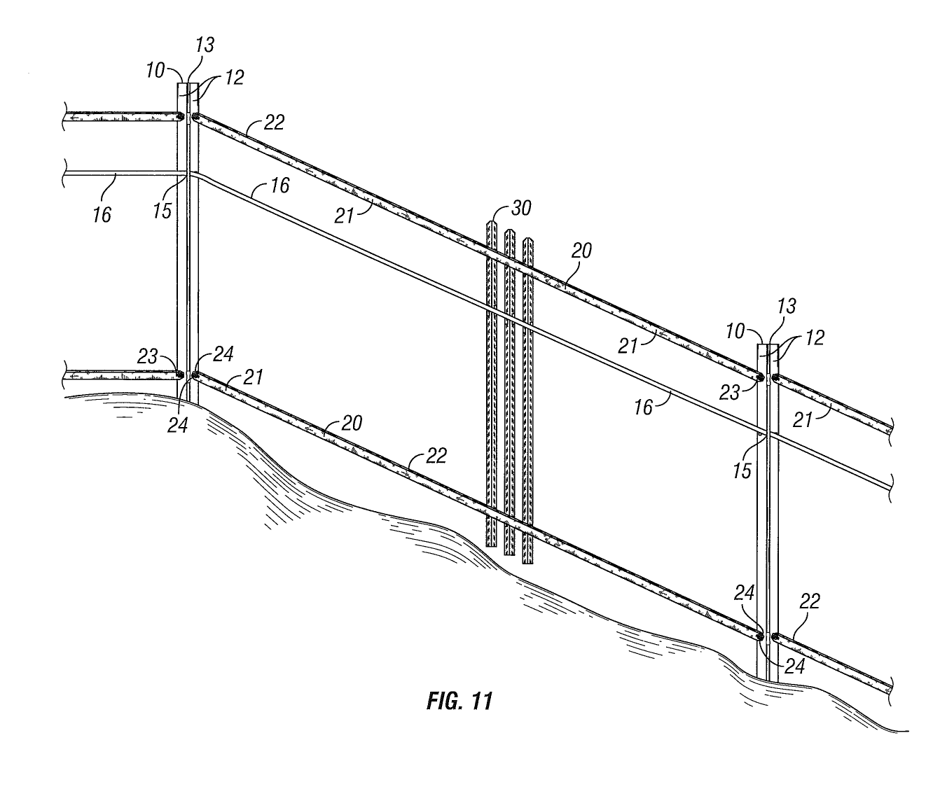

FIG. 11 illustrates a behind view of the fence system showing “racking” on a sloped terrain. In one example, pickets 30 are pivotally disposed on rail members 20. Rail members 20 are pivotally disposed on pole members 10 using elliptical rail hole 23. Rotational freedom about pole member 10 of rail members 20 is enhanced by tapered edges 24. The arrangement and configuration of the pole member, rail member combination, and picket combination enables the elevation of the fence to follow the sloped surface while at the same time greatly reducing time and costs during field installation.

Conduit or raceway 16, in this example, generally follows the elevation of the terrain by using elongated holes 15 that are at the same level on each pole member 10.

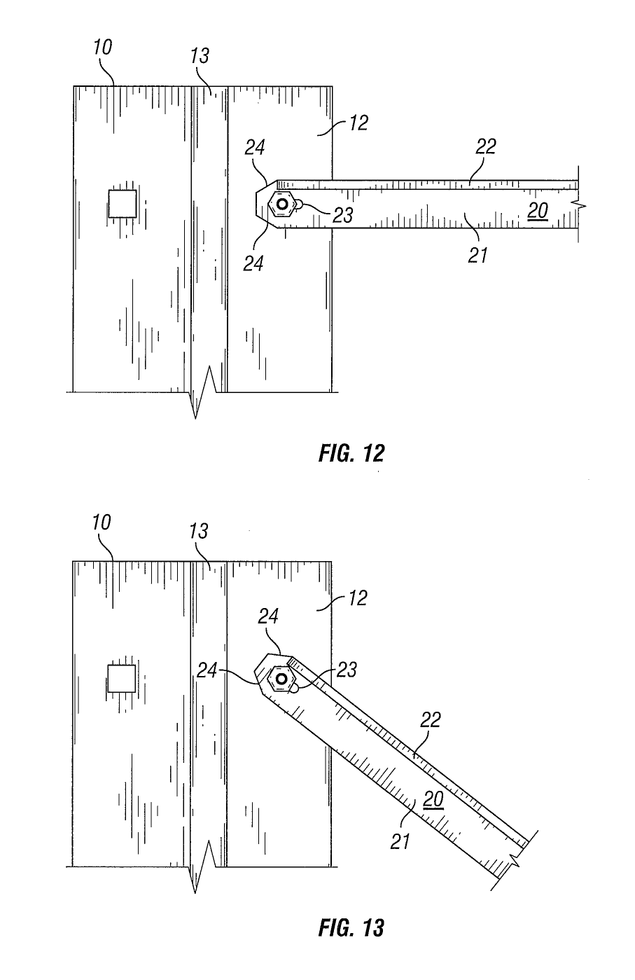

FIG. 12 illustrates a behind view of pole member 10 and pivotally attached rail member 20. Rail member 20 is received on the leg 13 side of receiving surface 22 of pole member 10. A fastener, such as a bolt, is inserted through receiving surface 12 and through elliptical hole 23. In this example, rail member 20 is generally perpendicular or horizontal relative to pole member 10. In one example, rail member 20 is securely fastened to pole member 10 to remove the pivotal freedom that was allowed during installation. In one example, the fastener secures the pole member and rail member combination by compression, fixing the final relative position between the pole member and the rail member. In one example, the fastener is a bolt and nut combination with the bolt having a locking shoulder that matches the receiving hole of receiving surface 22 of pole member 10.

FIG. 13 illustrates a behind view of pole member 10 and pivotally attached rail member 20. Rail member 20 is received on the leg 13 side of receiving surface 22 of pole member 10. A fastener, such as a bolt, is inserted through receiving surface 12 and through elliptical hole 23. In this example, rail member 20 is generally disposed and pivoted at an angle relative to pole member 10. Mitered or tapered end 24 of rail member 20 assists in allowing rotational freedom of rail member 20 relative to leg 13 of pole member 10.

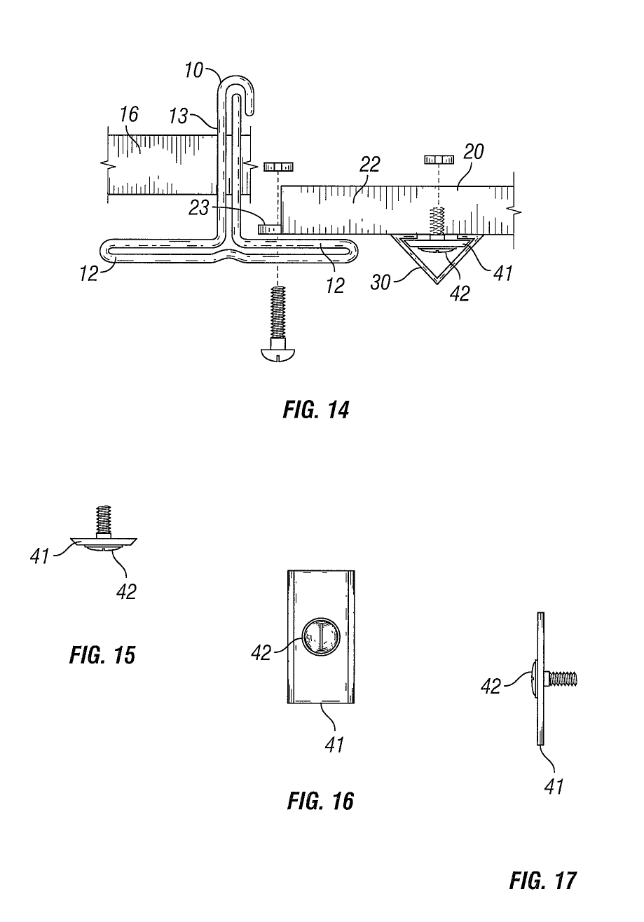

FIG. 14 illustrates a top view of rail member 20 with an example of attachment of picket 30. In one example, picket 30 is V-shaped with laterally protruding feet on the edges of the “V” to partially enclose the interior angle portion of the V-shape. In one example, the arms of the “V” are one inch wide and angled at 90 degrees relative to each other. The laterally protruding feet partially enclose the interior angle portion of the V-shape, leaving a three-quarter inch (0.75″) wide opening. A holding plate 41 acts as securing member to receive a bolt 42. Holding plate 41 fits in the interior of the V-shape of picket 30, which can be inserted from either end of picket 30, and is held within the interior angle portion of the V-shape by the laterally protruding feet. In one example, the width of holding plate 41 is fifteen-sixteenths of an inch ( 15/16″) which is greater than the three-quarter inch (0.75″) opening. Bolt 42 is inserted into holding plate 41 and then into rail member 20. A nut compressionally secures picket 30 and holding plate 41 to rail member 20.

FIG. 15 illustrates a top view of an example of holding plate 41 and bolt 42 for picket attachment. In one example, holding plate 41 has tapered side edges to provide a closer fit of holding plate 41 to the angled walls inside picket 30. Bolt 42 inserts through the face of holding plate 41.

FIG. 16 illustrates a front view of an example of holding plate 41 and bolt 42 for picket attachment. In one example, holding plate 41 is one and one half inches long (1.5″) and fifteen-sixteenths of an inch ( 15/16″) wide. In one example, holding plate 41 is square. In one example, holding plate 41 is fifteen-sixteenths of an inch ( 15/16″) wide and fifteen-sixteenths of an inch ( 15/16″) long. Bolt 42 is inserted through the face of holding plate 41, thereby disposing the head of bolt 42 in the interior side of picket 30. The tapers are expressed on the long sides of holding plate 41.

FIG. 17 illustrates a side view of an example of holding plate 41 and bolt 42 for picket attachment. Bolt 42 is inserted through the face of holding plate 41.

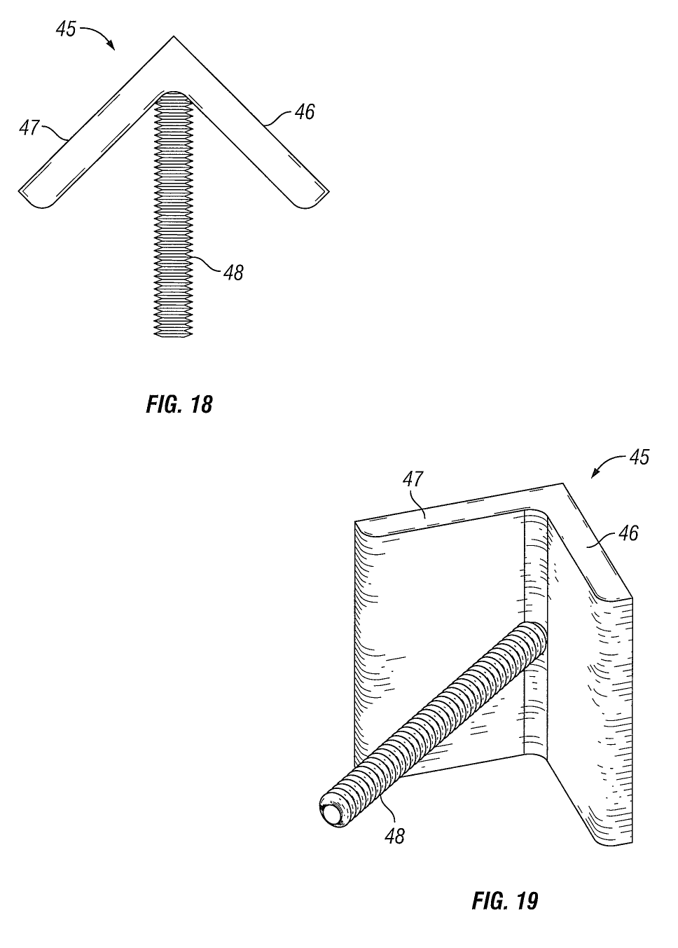

FIG. 18 illustrates a top view of an example of an integrated bolt 45 for picket attachment. In one example, the pickets are made from angle iron and have a hole in the middle of the angle. The pickets are mounted to rail member 20 with the 90-degree angle of the picket away from the rail. An integrated bolt 45 is designed with a head that is bent in the same angle of the picket, in one example forming two flat sides 47 and 47 set at 90-degrees to each other, similar to angle iron. Integrated bolt 45 has a threaded end 48 that slides through the picket and through the rail member. The angle of the bolt then clamps the picket to the rail and the unique design of the 90-degree double flat sided head makes the bolt head secure and tamper proof. The wide head also provides more surface area to help prevent the picket from being pried off of the rail member. These bolts also allow the fence to be racked to match grade changes of the ground. These bolts are secured to the rail member using a secure torque shear nut. The bolts and nuts are loosely tightened until the fence is complete. The bolt and nut are then torqued until the hex head shears off, preventing tampering with the nut. Applicant discovered that the angular fence rails, pickets, and “T” posts, stack very efficiently and take up much less space for shipping.

FIG. 19 illustrates a perspective view of an example of an integrated bolt 45 for picket attachment.

In one example, final assembly includes fixing the angle or pivot relationship between the pole member and the rail member such that the rail member is no longer free to pivot in relationship to the pole member. In a further example, the rail member is mounted with a carriage bolt. A secure shear nut is loosely mounted until the members are installed. The bolt and nut are then tightened fully until the head of the shear nut shears off. In another example, final assembly includes fixing the pivot relationship between the facing member, such as pickets 30, and the rail members such that the facing member is no longer free to pivot in relationship to the rail members. In these examples, “locking” the fence into place upon installation, especially along varying elevation in terrain, greatly reduces installation costs and time to install. In cases of installation in dangerous environments (such as along political borders or at military installations) time spent during installation may have strategic or safety significance in addition to pure cost, economy, and time considerations.

In one example, the fence system is designed as a cost reduction tool that allows utilities to be run through the post members instead of underground. Running of the utilities in the fence system instead of underground allows new construction to be later retrofitted, avoiding high cost of upgrading the facility. In another example, the fence system is capable of being removed or relocated when the system as installed is no longer required. This feature of re-usability creates a favorable impact on the environment. Current practice favors abandonment since excavation costs are high. In a further example, the fence system allows for currently known and future developed utilities and services—including those run through conduit, raceways, and/or piping—to be installed through the posts. Examples include, for example, high and low voltage electrical, water lines, gas lines, pest control, sensors, and communication, fiber, and security systems.

In another example, a perimeter security fence where CCTV cameras are being used, one would normally have to dig a trench and run a conduit to these locations for both power and data. The present fence system eliminates the additional work of having to disturb the ground and run conduit the entire length of the fence.

In further example, the fence system allows industry-approved devices to be run through the post members to maintain their full integrity and remain weather resistant and/or water tight. The fence system causes minimal interference to the shielding or guarding of the utility packaging. Another surprising result of the fence system is that the fence system can be installed by an installer and another party or the owner can install a utility at the time of fence installation or at some future time after the fence system is installed.

In further example, the total angle of bending can be minimized in the field. In one example, the post member includes equally spaced elongated holes, enabling the conduit carrying the utility to remain level as the terrain changes. The conduit is capable of being run with a reduced number and magnitude of bends. The elongated holes provide adequate clearance for the conduit to intersect the pole member at an angle, increasing the effective radius of curvature of the conduit, rendering many of the number and magnitude of bends unnecessary.

In another example, the arrangement and configuration of the components of the fence system enables the fence to follow non-level terrains while at the same time enabling conduit and pipe to travel independently of the non-level terrain. In one example, a one foot change in elevation of the terrain is compensated by selecting a different pole member hole for feeding through the conduit, pipe, or raceway. The conduit, pipe, or raceway therefore maintains its path without having to adjust for the change in grade.

Another advantageous discovery of the arrangement and configuration of the components of the fence system and the use of the leg of the pole member to support a raceway is that the conduit, pipe, or raceway can be terminated, change direction, or make any of a number of other types of transition at practically any point. In one example, where a new light or monitor needs to be run in a parking lot, the fence system reducing the amount of trenching or boring required to run power or communications from the source to the new installation. The utility carrying conduit, pipe, or raceway is run through the fence system to a point closest to the new installation site, leaving only the remaining distance from the fence to the new installation requiring any trenching or boring. At that point, for example, a shorter bore is made under the existing pavement from the light to the fence and the conduit is run underground to the light. This allows for faster, more cost effective method of running power for a light or communications lines for a monitor.

In one example of installation of the fence system, pole members 10 are either vertically driven in the ground or placed in concrete. At least one horizontal rail member 20 is pivotally connected to two adjacent pole members 10. In one example, rail member 20 is bolted to pole member 10 with hand tools and standard fasteners. In one example, the facing member, for example picket 30, is pivotally attached to rail member 20. In one example, the pivot relationship between the facing member and the rail member is fixed. At this point basic, fence construction is complete. To add utilities to the fence, conduit 16 is run through the elongated holes 15 of pole member 10. In another example, the conduit is installed after the pole members are set, but before the rails and pickets or facing member are installed. In another example, the fence is retrofitted with conduit or additional conduit at a later date. In another example, intrusion detection systems are installed after the fence is completed to prevent damage from rail and picket installation. In another example, cable reinforcement is done at any step of the process after the posts are installed. In another example, the pole members are placed in concrete footings. In another example, in areas where frost may be an issue, or for other preferences, the posts are driven into the ground.

In another example, the tops of the pickets are selectable with at least three different points: spear, crown, and traditional. The choice of picket top allows for gentle deterrent in low security requirements and more aggressive deterrent as more security is required.

The foregoing disclosure is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant in the art having the benefit of the present disclosure. Further, the embodiments described are also intended to explain the best mode for carrying out the invention, and to enable others skilled in the art to utilize the invention and such or other embodiments and with various modifications required by the particular applications or uses of the invention. It is intended that the claims based on this disclosure be construed to include alternative embodiments to the extent that is permitted by prior art.

1. A fence system comprising:
a T-shaped pole member having a receiving surface and a leg;
a rail member;
a facing member;
wherein the leg of the pole member has a plurality of spaced apart hole members capable of receiving a bendable raceway;
wherein the receiving surface of the pole member has a hole capable of providing means for pivoting and affixing the pole member to the rail or to the facing member;
wherein the rail member has an elliptical hole capable of providing means for pivoting and affixing the rail member to the receiving surface of the pole member;
wherein the rail member has a tapered edge proximate to the rail hole, the rail member capable of pivoting with respect to the pole member about the axis of the hole of the pole member;
wherein the combination of the pivotally affixed pole member and the rail member is capable of adjusting the fence system to non-level terrains; and
wherein the combination of the pole member and the rail member is capable of receiving the raceway between adjacent holes independent of the terrain and independent of the positioning of a plurality of the poles.

2. The fence system of claim 1 wherein the T-shaped pole member has fold-back edges.

3. The fence system of claim 1 wherein the rail member is L-shaped.

4. The fence system of claim 3 wherein the L-shaped rail member has fold-back edges.

5. The fence system of claim 3 wherein one pole member or one rail member has fold-back edges.

6. The fence system of claim 1 wherein the spaced apart hole members of the leg of the pole member are elongated along the longitudinal direction of the leg.

7. The fence system of claim 1 wherein the leg of the pole member further comprises a second set of holes, the second set of holes capable of receiving a set of restraining cables at a predefined spacing.

8. The fence system of claim 7 further comprising a set of restraining cables disposed through the second set of holes, the second set of holes positioned and arranged to comply with a crash resistant fencing standard.

9. The fence system of claim 1 wherein the fence system is capable of racking.

10. The fence system of claim 1 wherein the facing member comprises a plurality of pickets pivotally affixed to the rail members, forming a combination of pole members, rail members, and pickets.

11. The fence system of claim 1 wherein the facing member comprises a chain link web.

12. The fence system of claim 1 wherein the facing member comprises a wire mesh.

13. The fence system of claim 1 wherein the pole member and the rail member are positioned and arranged so as to be capable of adjusting the fence to non level terrains.

14. The fence system of claim 1 wherein the T-shaped pole member is a rolled form construction.

15. The fence system of claim 1 wherein the rail member is a rolled form construction.

16. The fence system of claim 1 wherein one pole member or one rail member is a rolled form construction.

17. A fence system comprising:
a T-shaped pole member having a receiving surface and a leg;
wherein the T-shaped pole member has fold-back edges;
wherein the T-shaped pole member is a rolled form construction;
wherein the leg of the pole member has a plurality of spaced apart hole members capable of receiving a bendable raceway;
wherein the spaced apart hole members of the leg of the pole member are elongated along the longitudinal direction of the leg; and
wherein the leg of the pole member further comprises a second set of holes, the second set of holes capable of receiving a set of restraining cables at a predefined spacing;
an L-shaped rail member;
wherein the L-shaped rail member has fold-back edges; and
wherein the L-shaped rail member is a rolled form construction;
a facing member;
a set of restraining cables disposed through the second set of holes, the second set of holes positioned and arranged to comply with a crash resistant fencing standard.
wherein the receiving surface of the pole member has a hole capable of providing means for pivoting and affixing the pole member to the rail or to the facing member;
wherein the rail member has an elliptical hole capable of providing means for pivoting and affixing the rail member to the receiving surface of the pole member;
wherein the rail member has a tapered edge proximate to the rail hole, the rail member capable of pivoting with respect to the pole member about the axis of the hole of the pole member;
wherein the combination of the pivotally affixed pole member and the rail member is capable of adjusting the fence system to non-level terrains;
wherein the combination of the pole member and the rail member is capable of receiving the raceway between adjacent holes independent of the terrain and independent of the positioning of a plurality of the poles;

18. A method for constructing a fence system comprising:
disposing a plurality of T-shaped pole members having a receiving surface and a leg, the leg of the pole member having a plurality of spaced apart hole members capable of receiving a bendable raceway, the receiving surface of the pole member having a hole capable of providing means for pivoting and affixing the pole member to a rail or to a facing member;
disposing a plurality of rail members on the T-shaped pole members, the rail members having an elliptical hole positioned and arranged so as to be capable of providing means for pivoting and affixing the rail member to the receiving surface of the pole member, the rail members having a tapered or mitered edge proximate to the rail hole, the rail member capable of pivoting with respect to the pole member about the axis of the hole of the pole member, whereby a combination of the pivotally affixed pole members and the rail members is formed;
positioning and arranging the combination of the pivotally affixed pole members and the rail members so as to be capable of adjusting the fence system to non-level terrains;
positioning and arranging the combination of the pole member and the rail member so as to be capable of receiving a raceway between adjacent pole member holes independent of the terrain and independent of the positioning of a plurality of the poles;
disposing a facing member on the rail members, the facing member pivotally affixed to the rail members;
inserting a conduit through a hole of the pole members;
fixing the pivot relationship between the pole member and the rail member; and
fixing the pivot relationship between the fencing member and the rail member.
